(19) United States
(12) Patent Application Publication
(10) Pub. No.: US 2022/0111360 A1
(43) Pub. Date: Apr. 14, 2022

(54) A METHOD FOR PREPARING A CATALYST FOR INFERIOR RESIDUAL OIL SUSPENDED BED HYDROCRACKING

(71) Applicant: FU ZHOU UNIVERSITY, Quanzhou, Fujian (CN)

(72) Inventors: Qingyan CUI, Fuzhou, FUJIAN (CN); Xiubin HU, Fuzhou, FUJIAN (CN); Xiaojun BAO, Fuzhou, FUJIAN (CN); Yuanyuan YUE, Fuzhou, FUJIAN (CN); Tinhai WANG, Fuzhou, FUJIAN (CN); Haibo ZHU, Fuzhou, FUJIAN (CN); Zhengshuai BAI, Fuzhou, FUJIAN (CN)

(21) Appl. No.: 17/264,296

(22) PCT Filed: Jul. 10, 2020
(86) PCT No.: PCT/CN2020/101217

§ 371 Date: Jan. 29, 2021

(30) Foreign Application Priority Data
Sep. 25, 2019 (CN) 201910908875.4
Apr. 16, 2020 (CN) 202010300182.X

(51) Int. Cl. B01J 23/745; B01J 37/00; B01J 37/04; B01J 37/06; B01J 37/08; B01J 37/10; B01J 35/10; C10G 11/04; B01J 37/03; B01J 37/02; C01G 49/06

(52) U.S. Cl. CPC B01J 23/745; C01P 2002/72; B01J 37/04; B01J 37/06; B01J 37/082; B01J 37/10; B01J 37/009; B01J 35/1014; B01J 35/1019; B01J 35/1038; B01J 35/1061; C10G 11/04; B01J 37/036; B01J 37/0236; C01G 49/06; C01P 2006/16; C01P 2006/14; C01P 2006/12; B01J 37/0018

(57) ABSTRACT

The present invention belongs to the technical field of petroleum processing, and specifically relates to a method for preparing a catalyst for inferior residual oil suspended bed hydrocracking. Using sol-gel method and hydrothermal method, a mesoporous γ-Fe₂O₃ catalyst suitable for inferior residual oil suspended bed hydrocracking with a high specific surface area was prepared, based on FeCl₃.6H₂O, Fe₂(SO₄)₃.xH₂O as inorganic iron source, and cheap sawdust powder as template. The present invention proposes to prepare a γ-Fe₂O₃ material with a mesoporous structure, a high specific surface area and a high pore volume using cheap raw materials and a simple and green synthesis process. The material as a catalyst has a good application effect in the heavy oil suspended bed hydrocracking reaction with a small amount, therefore having good commercial and industrial application value.

### CROSS-REFERENCE TO RELATED APPLICATIONS

This application claims priority to China Patent application No. 201910908875.4 filed Oct. 1, 2019, all of which are hereby incorporated herein in their entireties by reference.

### Field and Background of the Invention

The present invention relates to a method for preparing a catalyst for inferior residual oil suspended bed hydrocracking, in particular to a method for preparing a mesoporous γ-Fe₂O₃ catalyst.

With the continuous development of the national economy, the demand for light fuel oils such as gasoline, diesel, and aviation kerosene keeps increasing. However, since the trend of heavy and degraded crude oil is intensifying, and environmental protection laws and regulations have increasingly strict requirements on the quality of refined oil, the contradiction between the heavy and degraded crude oil and the lighter and cleaner products is becoming increasingly serious, which poses a serious challenge to the sustainable development of the refining industry. Efficient conversion of heavy oil is one of the main means to improve the utilization of crude oil and ensure energy supply. Efficient conversion and comprehensive utilization of heavy oil are extremely difficult due to its characteristics such as large molecular weight, complex composition, and high content of heteroatoms (S and N), metals (V and Ni), and asphaltenes.

Hydrotreating/cracking is a common method for converting heavy oil into light distillate. However, the currently widely used fixed-bed hydrogenation technology is not suitable for the treatment and conversion of low-quality feedstock due to its disadvantages such as poor ability of impurity removal, easy coking and deactivation of the catalyst, low conversion rate and son. Therefore, it is urgent to develop a new heavy oil hydrogenation technology. Among the existing heavy oil conversion technologies, the suspended bed hydrocracking technology is considered to be the most promising high-efficiency conversion technology for heavy oil due to its strong raw material adaptability, high conversion rate, and relatively simple process.

The catalyst is the core of the suspended bed hydrocracking technology, which not only plays a leading role in the reaction performance and the quality distribution of distillate, but also affects the long-term operation of the suspended bed reactor. At present, the suspended bed hydrocracking catalysts that has been developed mainly include oil-soluble catalysts, water-soluble catalysts and solid powder catalysts. Oil-soluble catalysts are organic compounds of transition metals (Mo. Ni, etc.), which are miscible with the feedstock oil to make the active substances highly dispersed. Oil-soluble catalysts are usually metal organic acid salts or organometallic compounds or complexes. This type of catalyst has high activity and low dosage, but with high cost for metal organic compounds. Water-soluble catalysts are inorganic salts of transition metal such as Mo, Ni, Co, etc., which can be used after being dissolved, emulsified, dehydrated, and sulfided. However, the complex and tedious preliminary preparation processes such as emulsification and dehydration are the main obstacles to the industrial application of this type of catalyst. Solid powder catalysts are mainly supported catalysts with alumina, coke and the like as carriers supporting transition metals such as Mo. Ni, Co and the like, and micron-sized iron-containing natural mineral fine powder catalysts. Supported catalysts have the disadvantages of high coke yield, large amount of catalyst, and high catalyst cost due to the use of transition metals Mo and Ni.

Natural iron ore has received widespread attention as a catalyst for heavy oil suspended bed hydrocracking due to its wide sources and low price. With red mud as the suspended bed hydrocracking catalyst, the conversion rate of vacuum residue is about 60%, the yield of gasoline and diesel is about 30%, and the yield of coke is about 5% under the conditions of 480° C. 15 MPa and 5 wt % of catalyst [Applied Catalysis A: General, 2012, 447-448, 186-192]; Matsumura et al. used limonite as a suspended bed hydrocracking catalyst with the active component Fe content of about 57 wt %, resulting in the conversion rate of vacuum residue of about 70%, and the coke production of about 3 wt % under the conditions of 450° C., reaction pressure 14.7 MPa, and catalyst dosage of 12 wt % [Fuel, 2005, 84, 417-421]; ExxonMobil uses Fe₂O₃ as a catalyst to carry out the suspended bed hydrocracking treatment of vacuum residue, resulting in the conversion rate of carbon residue in the vacuum residue of about 40% with a catalyst dosage of 7 wt %, at 440° C. and a reaction pressure of 20 MPa [1978, U.S. Pat. No. 4,067,799]. Petro-Canada mixes iron sulfate and petroleum coke into particles smaller than 30 μm as a catalyst, resulting in the conversion rate of asphaltene of 70%. under the conditions of a reaction temperature of 440, a reaction pressure of 14 MPa, and a catalyst amount of 5 wt % [1991. U.S. Pat. No. 4,999,328]. It can be seen that iron ore has a good application prospect as a catalyst for suspended bed hydrocracking, but the problems of low activity and large amount of the catalyst need to be solved. Iron oxides occur naturally in various crystal forms, and the common iron oxides includes α-Fe₂O₃, γ-Fe₂O₃, Fe₃O₄ and FeO. α-Fe₂O₃ and γ-Fe₂O₃ have the advantages of relatively simple preparation and relatively low price, more importantly, they have good effects in the residual oil suspended bed hydrocracking reaction. However, γ-Fe₂O₃ has more cation vacancies, but the active centers of the catalyst are mainly concentrated at the defect sites. Therefore, theoretically, the catalytic effect of γ-Fe₂O₃ in the residual oil suspended bed hydrocracking reaction is superior to that of α-Fe₂O₃.

In the process of heavy oil suspended bed hydrocracking reaction, the narrow pore structure of conventional Fe₂O₃ is difficult to meet the diffusion and mass transfer requirements of heavy oil macromolecules. Therefore, the main method to solve this problem is to prepare mesoporous Fe₂O₃ suitable for the diffusion and mass transfer of heavy oil macromolecules. The current methods for preparing γ-Fe₂O₃ mainly include: sol-gel method, hydrothermal method, co-precipitation method, template method, etc. to prepare Fe₂O₃ precursor, and calcining the precursor to obtain γ-Fe₂O₃. It has been reported the preparation of Fe₂O₃, for example, Guowei Zhou team prepares a mesoporous Fe₂O₃ with a pore size of 2-4 nm, using hydrothermal method with cetyltrimethylammonium bromide and didecyldimethylammonium bromide as templates and Fe₂Cl₃.6H₂O as an inorganic iron source (CN 105600833 A); Limeng Ma's research group prepares a mesoporous Fe₂O₃ with a specific surface area of 89 m²/g, a pore volume of 0.43 cm³/g and a pore diameter of 21.5 nm using sol-gel method with tetraethyl silicate, sucrose and F127 as templates, and ferric nitrate nonahydrate as an inorganic iron source (CN 106241884 A); Ping'an Chen et al. prepares a disk-shaped Fe₂O₃ with a particle size of 0.5-10 μm by mixing different types of iron salts and ammonium salts in a certain proportion followed by heating hydrothermally (CN 109574086 A); Dongdong Jia's research group prepares spherical nano-α-Fe₂O₃, using sol-gel method with urea as a template and iron nitrate as an inorganic iron source (CN 109999810 A); Feng Fan prepares a macroporous α-Fe₂O₃ by directly mixing beta molecular sieve with ferric nitrate (CN 109928428 A). At present, the template used in the synthesis of mesoporous Fe₂O₃ materials is expensive, the preparation process of which is complicated, and there is a certain pollution to the environment when the template agent is removed.

The present invention proposes to prepare a γ-Fe₂O₃ material with a mesoporous structure, a high specific surface area and a high pore volume using cheap raw materials and a simple and green synthesis process. The material as a catalyst has a good application effect in the heavy oil suspended bed hydrocracking reaction with a small amount, therefore having good commercial and industrial application value.

### SUMMARY OF THE INVENTION

The objective of the present invention is to provide a method for preparing a catalyst for inferior residual oil suspended bed hydrocracking. Using sol-gel method and hydrothermal method, a mesoporous γ-Fe₂O₃ catalyst suitable for inferior residual oil suspended bed hydrocracking with a high specific surface area was prepared, based on FeCl₃.6H₂O, Fe₂(SO₄)₃.xH₂O as inorganic iron source, and cheap sawdust powder as template. Wherein, the template agent plays a role in preventing the iron oxide skeleton from collapsing and inducing the formation of mesoporous structure during the crystallization process.

In order to achieve the above objective, the present invention adopts the following technical solutions: A method for preparing a catalyst for inferior residual oil suspended bed hydrocracking, comprising the steps of:

(1) adding an inorganic iron source to deionized water to prepare an inorganic iron source solution with a certain concentration, then immersed in a water bath;
(2) preparing an alkaline solution, which is slowly added to the inorganic iron source solution prepared in step (1) until final pH is 7.0-12.0;
(3) crushing the sawdust, followed by screening to obtain sawdust powder with the required particle size;
(4) dissolving the sawdust powder prepared in step (3) in a mixed solution of deionized water and absolute ethanol, with addition of organic solvent and alkali simultaneously, then immersed by stirring in a water bath, and set aside;
(5) adding the gel-like substance obtained from step (4) to the specimen prepared in step (2), with stirring quickly to form a gel substance;
(6) after the gel obtained from step (5) is left to stand, then dried, roasted, washed and dried again to prepare the catalyst.

The inorganic iron source used in step (1) is FeCl₃.6H₂O or Fe₂(SO₄)₃.xH₂O with higher purity than industrial purity, and the prepared inorganic iron source solution has a concentration of 2-8 mol/L.

Immersing in a water bath in step (1) is carried out at a speed of 400-700 r/min under a temperature of 50-90° C. for 0.5-5 h.

The alkaline solution used in step (2) is NaOH solution at a concentration of 2-7 mol/L.

A main component of a mixture formed in step (2) is Fe(OH)₃.

The sawdust powder in step (3) has a particle size of 20-40 mesh.

The prepared sawdust powder from step (3) is dissolved in a mixed solution of deionized water and absolute ethanol in step (4), wherein the weight ratio of deionized water to sawdust powder is 2:1-10:1; the organic solvent used in step (4) is isopropanol and glacial acetic acid, the alkali is NaOH, wherein the weight ratio of the added sawdust powder to the added isopropanol and the added sawdust powder to the added glacial acetic acid are both 10:1-10:3; the weight ratio of the added sawdust powder to the added NaOH is 10:3-10:8;

the stirring in a water bath in step (4) is carried out at a speed of 500-700 r/min under a temperature of 50-90′ for 1-5 h.

The gelatinous substance finally obtained in step (4) has a pH of 7.0-10.0.

The stirring quickly in step (5) is carried out at a speed of 1000-1300 r/min under room temperature for 10-60 min.

The gel substance finally formed in step (5) has a pH of 9.0-12.0.

The weight ratio of the added gel-like substance obtained from step (4) to the specimen prepared in step (2) is 1:10-4:6.

The standing time of the gel obtained from step (5) in step (6) is carried out under a temperature of 20-70° C. for 0.5-5 h, the first drying is carried out under a temperature of 80-170° C. for 5-9 h, calcining is carried out under a temperature of 380-500′C for 2-7 h.

The present invention has the following significant advantages:

(1) the mesoporous Fe₂O₃ prepared by the present invention has an average pore diameter of 7.00-15.00 nm, a pore volume of 0.03-0.35 cm³/g, and a specific surface area of 13.43-139.39 m²/g.

(2) the mesoporous Fe₂O₃ prepared by the present invention is γ-Fe₂O₃, which has good reaction performance under the conditions of inferior residual oil suspended bed hydrocracking reaction (with reaction temperature of 420° C., H₂ pressure of 13 Mpa).

### BRIEF DESCRIPTION OF THE DRAWINGS

FIG. 1 is a wide-angle XRD pattern of the mesoporous Fe₂O₃ catalyst prepared by the present invention;

FIG. 2 is a diagram showing the nitrogen absorption and desorption of the mesoporous Fe₂O₃ catalyst prepared in the present invention;

FIG. 3 is a pore size distribution diagram of the mesoporous Fe₂O₃ catalyst prepared in the present invention;

### DESCRIPTION OF THE PREFERRED EMBODIMENTS

The present invention will be further described below in combination with the drawings and specific embodiments, but the protection scope of the present invention is not limited this.

In order to avoid repetition, the raw materials used in the specific embodiments are described in a unified manner as follows, and details are not repeated in the examples.

The iron salt has higher purity than industrial purity.

The NaOH has higher purity than industrial purity.

### Example 1

(1) 27.05 g of FeCl₃.6H₂O was added to 39.2 ml of deionized water to prepare 2 mol/L FeClk solution under room temperature, then heated and stirred in a water bath under 80′C for 1 h;
(2) 6 mol/L of NaOH solution was prepared, which was added drop by drop to the FeCl₃ solution prepared in step (1) followed by production of red-brown floccules until the pH value of the solvent in the red-brown floccules greater than 11.2;
(3) the sawdust was crushed, followed by screening to obtain sawdust powder with a size between 20-30 mesh;
(4) 5 g of the sawdust powder prepared in step (3) was dissolved in a mixed solution of 40 ml deionized water and anhydrous ethanol (in mass ratio, deionized water:anhydrous ethanol=3:1), with addition of 2 g isopropanol, 5 g glacial acetic acid and 5 g NaOH (granular) simultaneously, followed by stirring under room temperature, then ultrasonic treatment for 1 h, and finally stirring in a water bath under 80° C. for 1.5 h;
(5) the final products of step (4) were added to the red-brown floccules prepared in step (2), with stirring quickly for 1 min to form a gel;
(6) after scaling the final gel made in step (5) in the reactor, it was left to stand at room temperature for 2 h, followed by drying under 150° C. for 5 h, and then roasting under 450′C for 3 h. Until the furnace temperature naturally dropped to room temperature, the sample was taken out and washed with a mixed solution of deionized water and alcohol, and then the sample was put in a 60° C. oven for drying, and finally the dried material was sealed and stored. Marked as Fe₂O₃-1.

The prepared iron oxide was γ-Fe₂O₃, with a specific surface area of 113.4 m²/g, a pore volume of 0.28 cm³/g, and an average pore diameter of 8.6 nm. The results of the catalyst used in the residual oil suspended bed hydrocracking reaction were shown in Table 1.

### Example 2

(1) 27.05 g of FeCl₃.6H₂O was added to 39.2 ml of deionized water to prepare 2 mol/L FeCl₃ solution under room temperature, then heated and stirred in a water bath under 80′C for 1 h;
(2) 6 mol/L of NaOH solution was prepared, which was added drop by drop to the FeCl₃ solution prepared in step (1) followed by production of red-brown floccules until the pH value of the solvent in the red-brown floccules greater than 11.2;
(3) the sawdust was crushed, followed by screening to obtain sawdust powder with a size between 20-30 mesh;
(4) 10 g of the sawdust powder prepared in step (3) was dissolved in a mixed solution of 40 ml deionized water and anhydrous ethanol (in mass ratio, deionized water:anhydrous ethanol=3:1), with addition of 2 g isopropanol, 5 g glacial acetic acid and 5 g NaOH (granular) simultaneously, followed by stirring under room temperature, then ultrasonic treatment for 1 h, and finally stirring in a water bath under 80′C for 1.5 h;
(5) the final products of step (4) were added to the red-brown floccules prepared in step (2), with stirring quickly for 1 min to form a gel;
(6) after sealing the final gel made in step (5) in the reactor, it was left to stand at room temperature for 2 h, followed by drying under 150° C. for 5 h, and then roasting under 450° C. for 3 h. Until the furnace temperature naturally dropped to room temperature, the sample was taken out and washed with a mixed solution of deionized water and alcohol, and then the sample was put in a 60° C. oven for drying, and finally the dried material was sealed and stored. Marked as Fe₂O₃.2.

The prepared iron oxide was γ-Fe₂O₃, with a specific surface area of 116.6 m²/g, a pore volume of 0.24 cm³/g, and an average pore diameter of 9.0 nm. The results of the catalyst used in the residual oil suspended bed hydrocracking reaction were shown in Table 1.

### Example 3

(1) 27.05 g of FeCl₃.6H₂O was added to 39.2 ml of deionized water to prepare 2 mol/L FeCl₃ solution under room temperature, then heated and stirred in a water bath under 80° C. for 1 h;
(2) 6 mol/L of NaOH solution was prepared, which was added drop by drop to the FeCl₃ solution prepared in step (1) followed by production of red-brown floccules until the pH value of the solvent in the red-brown floccules greater than 11.2;
(3) the sawdust was crushed, followed by screening to obtain sawdust powder with a size between 20-30 mesh;
(4) 10 g of the sawdust powder prepared in step (3) was dissolved in a mixed solution of 40 ml deionized water and anhydrous ethanol (in mass ratio, deionized water:anhydrous ethanol=3:1), with addition of 2 g isopropanol, 5 g glacial acetic acid and 5 g NaOH (granular) simultaneously, followed by stirring under room temperature, then ultrasonic treatment for 1 h, and finally stirring in a water bath under 80° C. for 1.5 h;
(5) the final products of step (4) were added to the red-brown floccules prepared in step (2), with stirring quickly for 1 min to form a gel;
(6) the final gel produced in step (5) was sealed in a high-pressure hydrothermal reactor with treatment under 150′C or 6 h, followed by drying under 150° C. for 6 h, and then roasting under 450′C for 3 h. Until the furnace temperature naturally dropped to room temperature, the sample was taken out and washed with a mixed solution of deionized water and alcohol, and then the sample was put in a 60° C. furnace for drying, and finally the dried material was scaled and stored. Marked as Fe₂O₃.3.

The prepared iron oxide was γ-Fe₂O₃, with a specific surface area of 126.4 m²/g, a pore volume of 0.35 cm³/g, and an average pore diameter of 9.5 nm. The results of the catalyst used in the residual oil suspended bed hydrocracking reaction were shown in Table 1.

### Example 4

(1) 27.05 g of FeCl₃.6H₂O was added to 39.2 ml of deionized water to prepare 2 mol/L FeCl₃ solution under room temperature, then heated and stirred in a water bath under 80′C for 1 h;
(2) 6 mol/L of NaOH solution was prepared, which was added drop by drop to the FeCl₃ solution prepared in step (1) followed by production of red-brown floccules until the pH value of the solvent in the red-brown floccules greater than 11.2;
(3) the sawdust was crushed, followed by screening to obtain sawdust powder with a size between 20-30 mesh;
(4) 5 g of the sawdust powder prepared in step (3) was dissolved in a mixed solution of 40 ml deionized water and anhydrous ethanol (in mass ratio, deionized water: anhydrous ethanol=3:1), with addition of 2 g isopropanol, 5 g glacial acetic acid and 5 g NaOH (granular) simultaneously, followed by stirring under room temperature, then ultrasonic treatment for 1 h, and finally stirring in a water bath under 80° C. for 1.5 h;
(5) the final products of step (4) were added to the red-brown floccules prepared in step (2), with stirring quickly for 1 min to form a gel;
(6) after sealing the final gel made in step (5) in the reactor, it was left to stand at room temperature for 2 h, followed by drying under 150′C for 5 h, and then roasting under 500° C. for 3 h. Until the furnace temperature naturally dropped to room temperature, the sample was taken out and washed with a mixed solution of deionized water and alcohol, and then the sample was put in a 60° C. oven for drying, and finally the dried material was sealed and stored. Marked as Fe₂O₃.4.

The prepared iron oxide was γ-Fe₂O₃, with a specific surface area of 71.1 m²/g, a pore volume of 0.20 cm³/g, and an average pore diameter of 15.3 nm. The results of the catalyst used in the residual oil suspended bed hydrocracking reaction were shown in Table 1.

### Example 5

(1) 27.05 g of FeCl₃.6H₂O was added to 39.2 ml of deionized water to prepare 2 mol/L. FeCl₃ solution under room temperature, then heated and stirred in a water bath under 80′C for 1 h;
(2) 6 mol/L. of NaOH solution was prepared, which was added drop by drop to the FeCl₃ solution prepared in step (1) followed by production of red-brown floccules until the pH value of the solvent in the red-brown floccules greater than 11.2;
(3) the sawdust was crushed, followed by screening to obtain sawdust powder with a size between 20-30 mesh;
(4) 5 g of the sawdust powder prepared in step (3) was dissolved in a mixed solution of 40 ml deionized water and anhydrous ethanol (in mass ratio, deionized water:anhydrous ethanol=3:1), with addition of 2 g isopropanol, 5 g glacial acetic acid and 5 g NaOH (granular) simultaneously, followed by stirring under room temperature, then ultrasonic treatment for 1 h, and finally stirring in a water bath under 80′C for 1.5 h;
(5) the final products of step (4) were added to the red-brown floccules prepared in step (2), with stirring quickly for 1 min to form a gel;
(6) after sealing the final gel made in step (5) in the reactor, it was left to stand at room temperature for 2 h. followed by drying under 150° C. for 5 h, and then roasting under 500° C. for 6 h. Until the furnace temperature naturally dropped to room temperature, the sample was taken out and washed with a mixed solution of deionized water and alcohol, and then the sample was put in a 60° C. oven for drying, and finally the dried material was sealed and stored. Marked as Fe₂O₃.5.

The prepared iron oxide was γ-Fe₂O₃, with a specific surface area of 13.4 m²/g, a pore volume of 0.02 cm³/g, and an average pore diameter of 16.6 nm. The results of the catalyst used in the residual oil suspended bed hydrocracking reaction were shown in Table 1.

FIG. 1 illustrated that the synthesized sample was γ-Fe₂O₃,

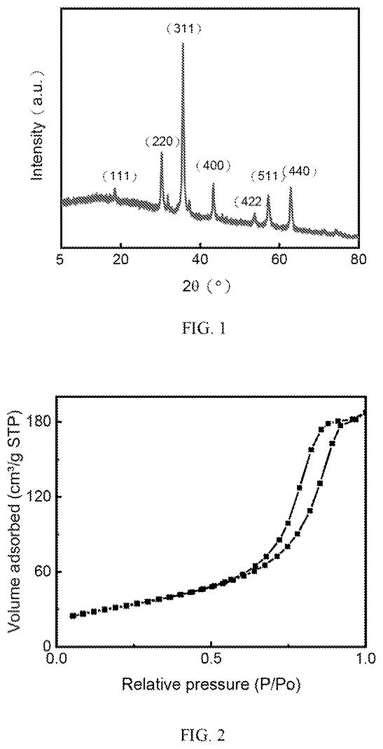

FIG. 2 illustrated that the synthesized γ-Fe₂O₃ had a mesoporous structure;

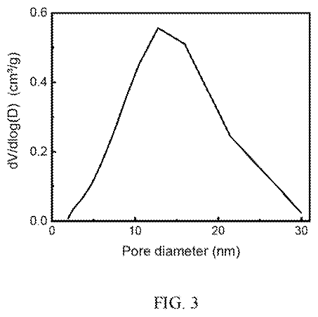

FIG. 3 illustrated the mesoporous average pore diameter of the synthesized γ-Fe₂O₃ was about 15 nm.

TABLE 1

| | | Gasoline | | | | | | |
|---|---|---|---|---|---|---|---|---|
| | | and diesel | Product distribution (wt %) | | | | | |
| | Conversion | yield | | | Middle | Decompression | Decompression | |
| Catalyst | rate (wt %) | (wt %) | Gas | Naphtha | distillate | fraction | residual oil | Coke |
| Fe₂O₃-1 | 86.6 | 51.6 | 22.7 | 23.1 | 28.5 | 12.3 | 10.6 | 2.8 |
| Fe₂O₃-2 | 90.9 | 60.0 | 21.3 | 25.7 | 34.2 | 9.7 | 8.0 | 1.1 |
| Fe₂O₃-3 | 87.0 | 57.2 | 23.8 | 27.9 | 29.3 | 6.0 | 11.0 | 2.0 |
| Fe₂O₃-4 | 89.0 | 54.6 | 21.9 | 23.7 | 30.9 | 12.5 | 8.7 | 2.3 |
| Fe₂O₃-5 | 88.8 | 52.2 | 22.5 | 20.9 | 31.3 | 14.1 | 8.5 | 2.7 |

The above examples are only preferred examples of the present invention, and are not intended to limit the scope of protection of the present invention. Any changes made by adopting the design principle of the present invention and performing non-creative work on this basis shall fall within the protection scope of the present invention.

1. A method for preparing a catalyst for inferior residual oil suspended bed hydrocracking, wherein the method comprises the steps of:
(1) adding an inorganic iron source to deionized water to prepare an inorganic iron source solution, then immersed in a water bath;
(2) preparing an alkaline solution, which is slowly added to the inorganic iron source solution prepared in step (1) until final pH is 7.0-12.0;
(3) crushing the sawdust, followed by screening to obtain sawdust powder with the required particle size;
(4) dissolving the sawdust powder prepared in step (3) in a mixed solution of deionized water and absolute ethanol, with addition of organic solvent and alkali simultaneously, then immersed by stirring in a water bath, and set aside;
(5) adding the gel-like substance obtained from step (4) to the specimen prepared in step (2), with stirring quickly to form a gel substance;
(6) after the gel obtained from step (5) is left to stand, then dried, roasted, washed and dried again to prepare the catalyst.

2. The method for preparing a catalyst for inferior residual oil suspended bed hydrocracking according to claim 1, wherein the inorganic iron source used in step (1) is FeCl₃.6H₂O or Fe₂(SO₄)₃.xH₂O with higher purity than industrial purity, and the prepared inorganic iron source solution has a concentration of 2-8 mol/L.

3. The method for preparing a catalyst for inferior residual oil suspended bed hydrocracking according to claim 1, wherein immersing in a water bath in step (1) is carried out at a speed of 400-700 r/min under a temperature of 50-90° C. for 0.5-5 h.

4. The method for preparing a catalyst for inferior residual oil suspended bed hydrocracking according to claim 1, wherein the alkaline solution used in step (2) is NaOH solution at a concentration of 2-7 mol/L; a main component of a mixture formed in step (2) is Fe(OH)₃.

5. The method for preparing a catalyst for inferior residual oil suspended bed hydrocracking according to claim 1, wherein the sawdust powder in step (3) has a particle size of 20-40 mesh.

6. The method for preparing a catalyst for inferior residual oil suspended bed hydrocracking according to claim 1, wherein the prepared sawdust powder from step (3) is dissolved in a mixed solution of deionized water and absolute ethanol in step (4), wherein the weight ratio of deionized water to sawdust powder is 2:1-10:1; the weight ratio of deionized water to absolute ethanol is 2:1-6:1.

7. The method for preparing a catalyst for inferior residual oil suspended bed hydrocracking according to claim 1, wherein the organic solvent used in step (4) is isopropanol and glacial acetic acid, the alkali is NaOH, wherein the weight ratio of the added sawdust powder to the added isopropanol and the added sawdust powder to the added glacial acetic acid are both 10:1-10:3; the weight ratio of the added sawdust powder to the added NaOH is 10:3-10:8; the stirring in a water bath in step (4) is carried out at a speed of 500-700 r/min under a temperature of 50-90° C. for 1-5 h; the gel substance finally obtained in step (4) has a pH of 7.0-10.0.

8. The method for preparing a catalyst for inferior residual oil suspended bed hydrocracking according to claim 1, wherein the stirring quickly in step (5) is carried out at a speed of 1000-1300 r/min under room temperature for 10-60 min; the gel substance finally formed in step (5) has a pH of 9.0-12.0; the weight ratio of the added gel-like substance obtained from step (4) to the specimen prepared in step (2) is 1:10-4:6.

9. The method for preparing a catalyst for inferior residual oil suspended bed hydrocracking according to claim 1, wherein the standing time of the gel obtained from step (5) in step (6) is carried out under a temperature of 20-70° C. for 0.5-5 h, the first drying is carried out under a temperature of 80-170° C. for 5-9 h, calcining is carried out under a temperature of 380-500° C. for 2-7 h.

10. A catalyst for inferior residual oil suspended bed hydrocracking prepared by the method of any one of claims 1-9, wherein the catalyst is mesoporous γ-Fe₂O₃, with an average pore diameter of 7.00-15.00 nm, a pore volume of 0.03-0.35 cm³/g, and a specific surface area of 14.0-140.0 m²/g.
